(19) United States
(12) Patent Application Publication
(10) Pub. No.: US 2003/0115162 A1
(43) Pub. Date: Jun. 19, 2003

(54) System and method for mail processing with verified sender identity

(76) Inventor: Michael Edward Konick, Painesville, OH (US)

Correspondence Address: KEITH J. BRODIE, 12 SILVEROAK, IRVINE, CA, 92620, US

(21) Appl. No.: 10/319,228

(22) Filed: Dec. 14, 2002

Related U.S. Application Data
(60) Provisional application No. 60/340,513, filed on Dec. 14, 2001.
(60) Provisional application No. 60/368,289, filed on Mar. 28, 2002.

(51) Int. Cl. G06F 17/60

(52) U.S. Cl. 705/404; 705/401

(57) ABSTRACT

The invention is a system and method for handling items to be shipped that securely verifies the sender. The invention makes use of pre-printed, unique, labels which are affixed by hand or machine to items to be mailed or shipped. These labels are packaged and distributed in groups. The groups of labels can be sold or freely distributed. Each person or organization that originates shipments is assigned a unique customer account number and their identity is authenticated when this account is created. The group number for a group of labels is linked to a customer account prior to the use of any of the labels from the group. The linking can be done at the time of sale or distribution of the group of labels, or after the sale or distribution thereof. Post-sale linking of a group of labels to a customer account can be done over the phone or through a web-site. The invention overcomes limitations in the prior art by creating a method for authenticating the sender of each item without requiring the use of a computer, printer, postage machine, or any other specialized hardware by the sender. The unique label identifiers are stored in a database that is used to ensure that each label that can be used only once. The invention is suitable for bulk mail processing and individual mail items. The invention provides a method for making selective use of specialized handling equipment, including equipment to irradiate the mail to destroy biological agents.

### CROSS-REFERENCE TO RELATED APPLICATIONS

This application seeks the benefit of provisional application Ser. No. 60/340513 filed Dec. 14, 2001 and provisional application Ser. No. 60/368289 filed Mar. 28, 2002.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### REFERENCE TO A MICROFICHE APPENDIX

Not Applicable

### BACKGROUND OF THE INVENTION

1. Field of the Invention

The invention relates generally to methods for handling items for shipment. More specifically, the invention relates to mail and packaging handling by the United States Postal Service (USPS), other postal services, and commercial shipping services. The invention also relates to the bar coded marking methods for machine-readable item identification and adaptation of handling methods in response thereto. The invention further relates to methods for franking and tracking mail.

2. Description of the Related Art

Currently mail and packages are accepted anonymously by the USPS and by various other public and private shipping services throughout the world. The USPS accepts anonymously originated packages in mailboxes and at post offices. Commercial shippers typically accept packages with payment and a signature. There is often no check on the actual identity of the shipper beyond the signature. This characteristic of anonymous origination, or unverified identification of the originator, allows for substantial criminal activity without recourse. Biological warfare agents, bombs, and threats have been sent through the mail. In some cases criminals have eluded law enforcement for decades using anonymously originated shipments. This is clearly a limitation in the current art.

The USPS has additional limitations in their current methods for handling mail and packages. There is extensive use of manual labor in the sorting, forwarding, holding, and handling of address changes. This introduces human error and adds unnecessary expense to the handling process. Some of these limitations are addressed, in the case of bulk mail, by the use of bar coded labels. Bar coded bulk mail offers the potential to identify the originator and the addressee, but the bar codes are easily forged.

The requirements on the USPS and other shippers have increased markedly in recent months. The anthrax attack on the U.S., carried out through anonymously posted hand-addressed mail items highlights the limitations in the current art.

There is substantial prior art in the field addressing the issues of automated handling, identifying the sender, and providing unique tracking identifiers for processing of mail or shipped items. Some examples of prior art related to the present invention include U.S. Pat. No. 4,725,718 by Sansone et al., Postage and Mailing Information Applying System, which discloses an encrypted label affixed to, or an encrypted message printed on, a mail piece to authenticate the sender, payment and addressee. In contrast to the present invention, the label is printed with specialized hardware by the sender.

U.S. Pat. No. 4,999,481 by Baer et al., Method and Apparatus for Sequentially Numbering Mail Pieces discloses a method for printing a unique identifier on each piece of mail from a postage meter. The sender must have a postage meter to use the system.

U.S. Pat. No. 5,202,834 by Gilham, Mail Item Processing System discloses a system in which unique machine-readable indicia are transmitted to a sender for printing on mail items, to be verified by the postal authority when handling the mail item to verify the sender and postage. The sender must have the specialized apparatus to receive and print the indicia.

U.S. Pat. No. 5,420,403 by Allum et al., Mail Encoding and Processing System discloses a method for encoding a destination address on a mailpiece to allow for automated handling, where the codes may be applied by the customer or the carrier, or both, to allow for sorting, special handling, and payment accounting. In the case of customer encoding, the customer is required to use specialized equipment. In the case of carrier encoding, there is no mechanism disclosed to authenticate the sender.

U.S. Pat. No. 5,586,037 by Gil et al., Automated Self-Service Mail Processing and Storing System discloses an automated mailbox where mail items are received and secured and may be affixed with a unique machine-readable label printed at the mailbox.

U.S. Pat. No. 5,612,889 by Pintsov et al., Mail Processing System with Unique Mailpiece Authorization Assigned in Advance of Mailpieces Entering Carrier Service Processing Stream discloses methods for handling mail wherein each mailpiece is assigned a unique code representing the delivery address. The codes may be encrypted, and printed on the mailpiece prior to entry into the mail system or applied during processing by the carrier service. The codes serve to validate payment from the sender's account and direct handling associated with the delivery address, such as applying a forwarding address for a given destination address. The sender is required to use specialized mail processing equipment.

U.S. Pat. No. 5,717,597 by Kara, System and Method for Printing Personalized Postage Indicia on Greeting Cards, discloses a method for printing a postage mark on a card or label which uniquely identifies the sender. The sender uses a personal computer augmented with coded postage data obtained through various mechanisms.

U.S. Pat. No. 5,937,762 by Herbert, Apparatus for Printing Postal Impressions and Method of Identifying Origin of Postal Impression, discloses a postage machine in which the machine which franked the mail may be uniquely identified with special inks and other methods to authenticate the code of the originating machine.

U.S. Pat. No. 6,009,416 by Pintsov, System and Method for Detection of Errors in Accounting for Postal Charges in Controlled Acceptance Environment, discloses a method for bulk mail in which mail pieces are assigned unique, encrypted identifiers which are machine-read by the carrier to verify sender and postage. Specialized mailing equipment is utilized.

U.S. Pat. No. 6,233,565 by Lewis et al., Methods and Apparatus for Internet Based Financial Transactions with Evidence of Payment, discloses systems and methods for carrying out a secure payment transactions over the internet. The methods allow for the payer to print a unique receipt or label for the transaction, which could be used as postage. The sender uses a personal computer to interact with the secure server and print the receipt or postage.

U.S. Pat. No. 6,249,777 by Kara et al., System and Method for Remote Postage Metering discloses a method for obtaining a printable image indicative of postage paid through a network, where the image may include information uniquely identifying the sender.

U.S. Pat. No. 6,282,525 B1 by Kubazki et al., Method and Arrangement for Data Processing in a Mail Shipping System Having A Postage Meter Machine Wherein a Carrier-Identifying Mark is Scanned and Processed, discloses a sophisticated postage metering machine with the capability to frank mail for more than one carrier with postage accounting. This invention and similar devices uniquely identify the sender through the use of the printed franking marks.

U.S. Pat. No. 6,427,032 by Irons et al., Apparatus and Method for Digital Filing discloses a document filing system in which sets of preprinted labels with unique identifiers are distributed to users of the system. Users apply labels to documents to be scanned and stored. The unique identifier labels, coming from groups of labels distributed to individual users, serve to identify the user entering the document into the system.

U.S. Pat. No. 6,438,530 by Heiden et al., Software Based Stamp Dispenser, discloses a system for printing unique labels on mailpieces which identify the sender. A computer and printer are used by the sender.

### BRIEF SUMMARY OF THE INVENTION

To minimize the limitations in the prior art, and to minimize other limitations that will become apparent upon reading this specification, a system and method for handling items to be shipped that securely verifies the sender is disclosed. The present invention makes use of pre-printed, unique, labels which are affixed by hand or machine to items to be mailed or shipped. These labels are packaged and distributed in groups. The groups of labels can be sold or freely distributed. Each person or organization that originates shipments is assigned a unique customer account number and their identity is authenticated when this account is created. The group number for a group of labels is linked to a customer account prior to the use of any of the labels from the group. The linking of a group of labels to a customer account can be done at the time of sale or distribution of the group of labels, or after the sale or distribution thereof. Post-sale linking of a group of labels to a customer account can be done over the phone or through a web-site. The invention overcomes limitations in the prior art by creating a method for authenticating the sender of each item without requiring the use of a computer, printer, postage machine, or any other specialized hardware by the sender. The unique label identifiers are stored in a database that is used to ensure that each label that can be used only once. The invention is suitable for bulk mail processing and individual mail items. The invention allows a customer account to be identified for each shipped item, but does not directly disclose customer account information on the shipped item. This is in contrast to the labeling methods used by some commercial shippers, which print the originator's account number on the package to be sent. The invention, therefore, provides added security for the originator as well as the shipping service and recipient. The invention provides a method for making selective use of specialized handling equipment, including equipment to irradiate the mail to destroy biological agents. As a result of these advantages and other advantages that will become apparent upon reading this specification, the invention enhances the public safety. It also enhances the safety and efficiency of the shipping service itself.

An object of the present invention is to provide for verification of the identity of the originator of a shipped item without requiring the use of specialized processing equipment or a computer by the sender.

A further object of the present invention is to provide for verification of the originator of hand-addressed mail or packages.

Another object of the present invention is to provide a method to identify mail items for special handling by the shipper, where special handling includes but is not limited to routing the mail item around irradiation equipment.

Still another object of the present invention is to provide a unique mail item identifier to each mail piece and allow for tracking the mail item's progress through the mail processing system.

Yet still another object of the present invention is to provide a mail-piece tracking history. The tracking history allows for determination of which specific pieces of mail-handling equipment the mail item passed through. By doing so, the present invention fulfills another objective: it allows for a cross-contamination analysis which compares the tracking history of a mail item against the tracking history of a known or suspected contaminated item to determine if it may have been contaminated as well.

Another object of the invention to enhance the safety of workers in the shipping service, by either eliminating anonymously originated mail items, or by reducing the amount of anonymously originated items so that they can be treated with more caution than would otherwise be practical.

A still further object of the present invention is to provide a system for introducing customer accounts for tracking sent items, where the system can accommodate a gradual transition from a largely anonymous sender system to a system that eliminates anonymous origination.

### BRIEF DESCRIPTION OF THE SEVERAL VIEWS OF THE DRAWING

Some of the figures include copyrighted material and are so marked. Permission is granted for duplication of the copyrighted material as part of the patent application or resulting patent. All other copyright rights are reserved.

FIG. 1 is a flowchart of the shipped item handling process at a processing center for the USPS embodiment of the invention.

FIG. 2 is a stacked bar code embodiment of the V-STAMP label.

FIG. 3 is an embodiment of the table structure comprising the V-STAMP database.

FIG. 4 is a contamination exposure map describing the result of a V-STAMP database query.

FIG. 5 is an embodiment of a web-page interface for initiating a contamination check on a shipped item.

FIG. 6(a),(b) are embodiments of a web-page results for contamination checks on shipped items.

FIG. 7 is an embodiment of the V-STAMP Shipper, a form used to specify special shipping in accordance with the present invention.

FIG. 8 is an embodiment of the reverse side of the V-STAMP Shipper form given in FIG. 7.

FIG. 9 is am embodiment of a receipt form for an item shipped with a V-STAMP Shipper in accordance with the present invention.

### DETAILED DESCRIPTION OF THE INVENTION

### Glossary

Throughout this disclosure reference is made to some terms which may or may not be exactly defined in dictionaries as they are defined here. The following definitions of terms are presented so as to clarify the scope of the disclosure. Although every effort to be precise and thorough has been made, it is not possible that all meanings associated with each term can be completely set forth. Accordingly each term is intended to also include its common meaning derived from general usage within pertinent arts and its dictionary meaning. Where the presented definition is in conflict with a dictionary or arts definition, one must consider the context of use to arrive at an intended meaning. In this case, however, given the wide possible variations in the arts definition among practitioners, it is not reasonable to presume a particular arts definition that is in conflict with a definition presented in this disclosure. An arts definition, therefore, should be viewed as potentially broadening the meaning of a term defined here, but not constraining it or contradicting it.

Database

The term database is used throughout this disclosure, the V-STAMP database is a critical component in the present invention. The meaning of the term database as used in this disclosure is broad. It means an apparatus capable of storing digital data in a fashion organized into large numbers of records of a plurality of types.

The term as used here is meant to be either a centralized or distributed database. Each instance of the present invention uses one form of the database or the other, but both are within the scope of the invention. In a centralized database the storage device or devices holding the records are accessed by a single central processing unit (CPU). The single CPU is the gatekeeper for the records, responsive to queries, record insertions and record updates, and ensuring the integrity of the records in the database. In a distributed database, the storage devices holding the records are accessed by multiple CPU's. The CPU's are interconnected through a digital communications means, such as a local area network (LAN), the Internet, a digital data bus, or some composite of these digital communications links. The database software is responsible for maintaining the integrity and consistency of the records across the multiple CPU's and storage devices. Methods for hosting and using a database distributed across multiple CPU's and storage devices in multiple locations are well-known in the current art, and include all of the necessary synchronization and routing to ensure that records are stored consistently.

Phrases are used which include the term database that are a shorthand for a complete description of a database transaction. The shorthand phrases are adopted because to repeat a complete description of the database transaction for each transaction discussed in this disclosure would render the disclosure unreadable, and is not consistent with clarifying the scope and intended operation of the present invention. For example, the disclosure uses a phrase such as “the scanner reads the V-STAMP label and creates a track history record to be inserted into the V-STAMP database track history table”. The phrase can be expanded to say that a local processor connected to or embedded in the scanner that read the V-STAMP label assembles a digital message comprising the date, time, the unique V-STAMP label identifier and its own handling point identification code. This message is transmitted to the processor (centralized database structure) or one of the processors (distributed database structure) hosting the V-STAMP database. The communications link can be a local area network, a digital data bus, the Internet, or any other digital communications mean, or some composite of one or more links of any of these types. The destination processor hosting the V-STAMP database reads the message, formats it into a record, and inserts it into the track history table using database software as is common practice in the art.

In order to have a disclosure that can be read and understood, the shorthand phrases for the database transactions are adopted rather than repeat this more complete description for each database transaction discussed. Records in tables in the V-STAMP database are inserted, retrieved, and updated. Updating means they are retrieved, modified, and stored again. Each of these transactions occurs through the mechanism described in the preceding paragraph, there is a local processor responsive to data from the database or generating data for the database. That data is passed between the local processor and the database processor through one of the communications mechanism described above. The database software handles these transaction types and retrieves, modifies, or writes records in the database in order to carry out the transaction as is common practice in the art.

Handling Point

A shipping service handles shipped items with equipment that physically come in contact with the shipped items. This equipment is referred to as a handling point in this specification. Handling points include but are not limited to scanner stages, conveyor belts, sorters, mailbags, and cargo containers. In the present invention, some of these handling points are assigned unique identifiers.

Originator

The originator is a person or an organization that initiates a shipment. The originator has the item to be shipped, and is the party responsible for determining the destination address. The originator may utilize an outside packaging service or secondary delivery service. The packaging service or secondary delivery service may actually deliver the item to the primary shipping service or hold it for pick-up by the primary shipping service, nevertheless, the originator is the person or organization which initiated the shipment, not the packaging service or secondary delivery service.

Processor

The term processor is used to refer to a computer of some type. The processor could be a local computer, or it could be remote from the user and accessed by some communication method such as the internet, a proprietary network, phone lines, radio links, or any combination comprising one or more instances of these link types. In the case of a remote processor, a local device has simplex or duplex communication with the remote processor. The local device may be another processor, a terminal, a bar code scanner, a fingerprint scanner, a retinal scanner, a phone or any other device supporting communication with a computer.

In addition, the term processor as used in this specification, does not imply a single (CPU). The term processor is intended to include computers with multiple CPU's and distributed processing systems, where the CPU's are not physically in the same enclosure.

Recipient

The recipient is the person or organization to which a shipped item is addressed to, and to whom it is delivered if the shipping is successful.

Shipped Item

The shipped item refers to a package or letter or any other item handled by a shipping service to be delivered to an address. The shipped item is physical, rather than electronic, and the address is physical, a geographical location. Shipped item therefore, includes anything sent through the US and foreign postal services. It also includes items handled by private firms such as Federal Express, UPS, DHL and others.

Shipping Service

The shipping service receives an item to be shipped and handles it in the process of sorting, transporting, and delivering it to the destination address. The USPS, foreign postal services, and private firms such as Federal Express, UPS and DHL are all examples of shipping services. The shipping service may make use of contractors or outside shipping services to complete some or all of the segments of the actual shipping path, nevertheless the shipping service is the organization with whom the customer entrusts the responsibility for the end-to-end delivery of the shipped item.

SSN

An acronym for social security number.

USPS

This is an acronym for the United States Postal Service.

V-STAMP™

The name V-STAMP has been coined to refer to the present invention. V-STAMP is an acronym for Verified, Secure, Tracking Accounts for Mail Processing. References to V-STAMP are references to the entire system and method disclosed. References to components of the system also comprise the component name, for example, the V-STAMP label is the label affixed to a shipped item comprising a unique combination of machine-readable codes.

### INTRODUCTION

The present invention, V-STAMP, is a system and method for improving shipping safety and security by identifying the originator of shipped items. The key components of the system are the label, the database, the customer account, the scanning equipment, and the shipper. The invention is applicable to any public or private shipping service, and can be used to augment existing shipping services. The invention can be introduced as a mandatory part of the shipping process, applicable to all items shipped by a shipping service, or it can be used on some items only.

### EXAMPLE OF OPERATION

The preferred embodiment of the system is as an upgrade to the USPS. In order to give an overview of the system, it will be described from the point-of-view of a postal customer employing the preferred embodiment. The customer, for purposes of the example, is a private citizen mailing a letter. The steps the customer follows as the originator of the letter, and the subsequent processing by the USPS are discussed. It is the intention of presenting this example to make clear the intended operation of the invention as a whole in the preferred embodiment before beginning the detailed discussion of the parts. There are variations in the system, its component elements, and the methods used beyond those given in this example that are within the scope of the invention. Some of these are presented subsequently and some are obvious substitutions of elements or methods to accomplish the same function.

The customer must establish a customer account to make use of V-STAMP. In order to do this they go to the post-office and identify themselves. In the preferred embodiment, they identify themselves by presenting a driver's license, a social security card, and submitting to a fingerprint scan. This data is assembled along with their address, phone number(s), and optionally a credit card account type, number and expiration date into a new customer account record on a processor at the post-office. The post-office processor sends it to the processor hosting the V-STAMP database. A new customer account record is entered into the V-STAMP database and assigned a unique customer code. The customer code is returned to the post-office processor. The post-office processor has connectivity to a printer, which prints a summary of the new account information, including the customer's code. The printed summary is returned to the customer as a record the account information, including the customer code.

From his or her home, the customer then orders a package of V-STAMP labels by calling a toll-free number for V-STAMP orders. A package of 100 V-STAMP labels with their label group code printed on the outside of the package is delivered to the customer's address by the postal carrier. After receiving the V-STAMP labels, the customer calls a toll-free number from his home for V-STAMP verification. On the verification call, the customer reads in his or her V-STAMP customer code, from the account information printed out at the post office, and the group code from the package of V-STAMP labels received from the carrier. Voice recognition software running on the processor responsive to the verification phone line is connected to the processor hosting the V-STAMP database. The voice-recognition software recognizes the customer code and checks the V-STAMP database to see if such a customer account exists by querying the Customer Table in the V-STAMP database. If it does, the computer then verifies the customer's phone number through caller-ID processing. If the spoken customer account code exists in a record in the V-STAMP database Customer Table and the phone number of the caller matches any of the phone numbers given when the customer account was set-up, the V-STAMP labels are verified to have been delivered to a known customer. The computer also recognizes the V-STAMP label group code spoken by the customer and checks the database to determine if this is a valid group code. By valid, what is meant is that a group of labels with the group code was produced, and they were not assigned to another customer, and they have not expired. If the group code is valid an entry is recorded in the V-STAMP database Assigned Group table assigning the group code to this customer code. Additionally, each of the records in the Label Status table with a matching group code are updated to set the assigned flag true. All of the V-STAMP labels in the group are now known to be in the possession of a customer with an account in the V-STAMP database, and for whom the database is holding verified identification information.

Next the customer writes a letter, addresses it by hand, affixes a postage stamp and a V-STAMP to the letter. The V-STAMP label is one of the V-STAMP labels from the group of labels delivered by the carrier, and verified to have been delivered by the phone call. The letter is dropped in a mailbox. The mail carrier empties the box and drops the mail off at the local post office, which is also a processing center.

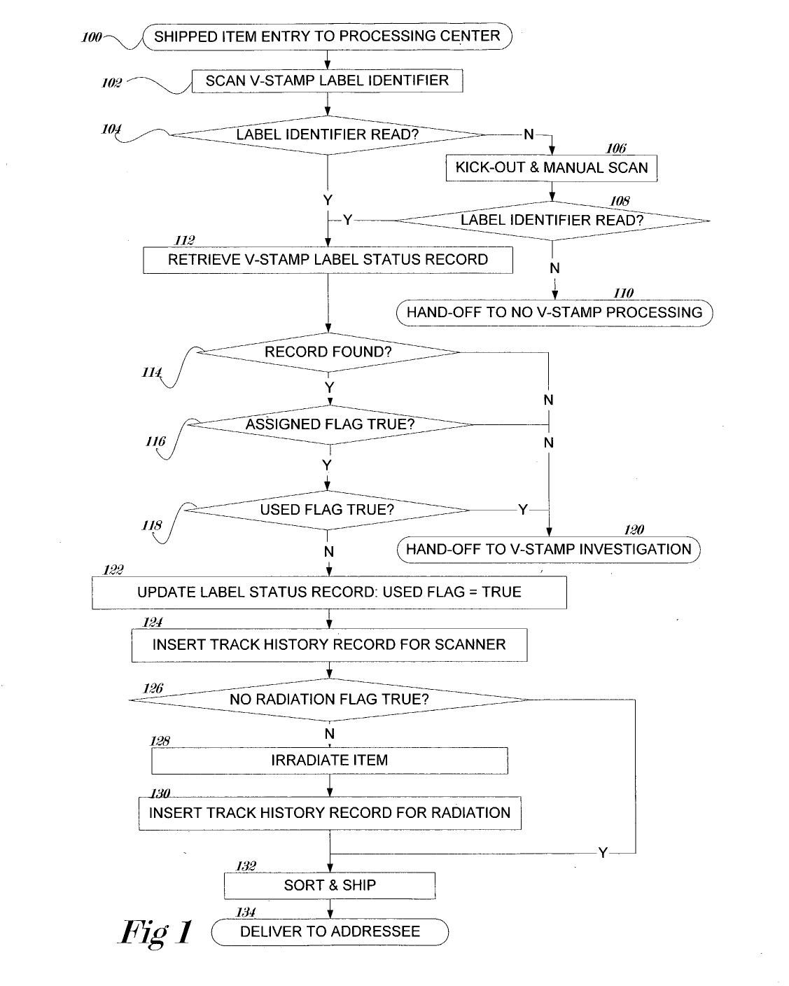

The processing of the letter at the postal processing center is described by the flowchart given in FIG. 1. The letter is first scanned (102) and the machine-readable V-STAMP label codes are read (104). If the scanner fails to read the V-STAMP label identifier, the item is kicked out for manual scanning (106). If the label cannot be manually scanned, the item is not marked satisfactorily and is set aside for processing without making use of the present invention (110). If the present invention is adopted as the only means by which the USPS will process mail items, then the termination of V-STAMP processing (110) would result in return-to the sender or some other handling mechanism for unmarked items. If the present invention is adopted as an optional augmentation to a baseline processing method not using V-STAMP, then the hand-off (110) is to the baseline processing method.

In the case where the V-STAMP label has been read, the unique identifier from the V-STAMP label is used to initiate a query in the label status table in the V-STAMP database for the label status record corresponding to the unique identifier on this V-STAMP label (112). If this query does not return a record, then the label is suspect, as no record of its production exists in the database. In that case, further investigation is warranted (120) as the label may be a forgery.

If the label status record is found, the assigned flag field in the record as is tested. If the flag is false, then the V-STAMP label affixed to the item comes from a group of V-STAMP labels that has not been verified to have been delivered to a customer. Once again, this is a cause for investigation (120), it may simply be a mistake, or it may be an attempt to subvert the invention and pass an anonymously originated mail item into the system.

If the assigned flag test is passed, the used flag field of the label status record is tested (118). If the flag is true, then the V-STAMP database has a record of a prior item shipment using the same V-STAMP label, and this is also a cause for investigation (120). Attempted forgery or duplication of a real V-STAMP label may be the cause.

If the used flag was false, processing continues by updating this label status record in the V-STAMP database to set the value of the used flag field to true (122). Once set true, any other items presented for shipment with the same unique V-STAMP label identifier will be identified as potential duplications when the used flag field is tested (118) on their passage through the processing flow.

A track history record is created and inserted into the V-STAMP database for the item (124). The track history table in the V-STAMP database stores the history of a V-STAMP labeled mail item as it passes through the USPS. It is described in more detail in the V-STAMP database section of this disclosure. The record created contains the unique identifier for the V-STAMP label, the date and time, and an identifying code associated with the scanner performing the initial read of the label (102).

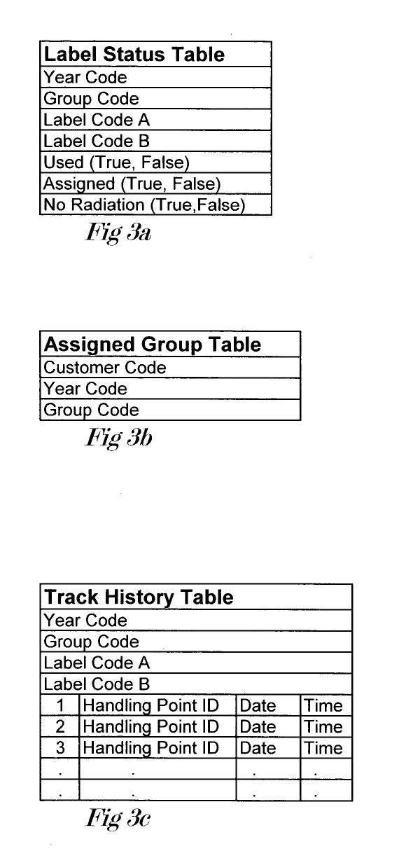

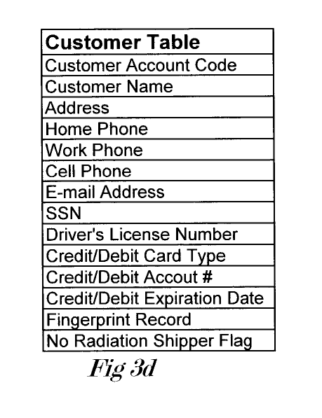

The label status record from the label status table in the V-STAMP database, FIG. 3a contains an “no radiation” field which is normally false, but can be set true under conditions specified later in this disclosure. The value of this field is tested in the label status record retrieved (126). If the field is true, the item is not to be radiated. If it is false, the item is irradiated (128) and a second track history record for this V-STAMP label unique identifier is created by a processor associated with the radiation device and inserted into the track history table of the V-STAMP database (130).

The sort and ship step in the process (132) is a summary step encompassing the sorting and shipping of mail items as is current practice at the USPS. The process is unaltered except for the fact that the V-STAMP label is scanned at various points throughout the processing and a track history record is created and inserted in the V-STAMP database as a result of some or all of these scans. The letter is eventually sorted out to a carrier and delivered to its destination (134). It leaves behind a track history in the V-STAMP database, including the originator, and what time it passed through various handling points in the postal system.

With this example of the operation of the preferred embodiment of V-STAMP processing as background, more explicit description of the components and processes comprising the present invention is now set forth.

### THE V-STAMP LABEL

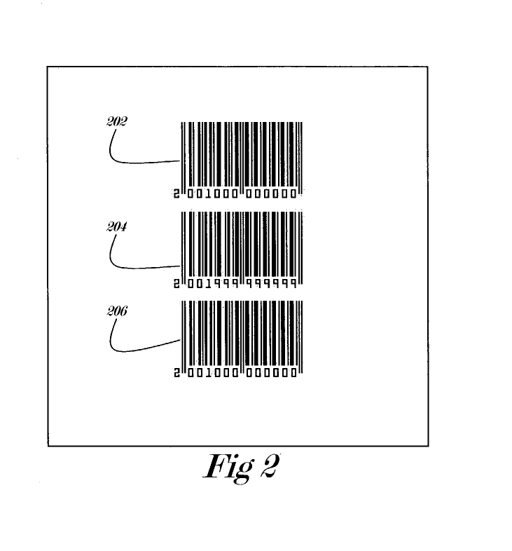

The V-STAMP label is a machine-readable printed label. It is produced with an adhesive backing so that it can be affixed to a shipped item, such as an envelope or package. The label has a unique identifier comprising one or more codes, which are printed in a machine-readable format on the label such that they are visible when the label is affixed to a shipped item. No two V-STAMP labels are printed with the same label identifier. FIG. 2 is an embodiment of the V-STAMP label using three stacked bar codes to present the label identifier.

The V-STAMP label identifier has four independent data elements. The four data elements are:

1) the 4-digit year code for the year the stamp was produced,

2) a 9-digit group code,

3) a first 9-digit label code “A”, and

4) a second 9-digit label code “B”.

In the stacked bar code embodiment of FIG. 2, the top 13 digit bar code (202) is the 4-digit year code followed by the 9 digit label code A. The second bar code (204) is the year code followed by the 9-digit label code B. The bottom bar code (206) is the year code followed by the 9-digit group code. The set of all four data items, the year code, group code, label code A and label code B comprise the label identifier.

The randomly generated codes; label codes A, label code B, and the group code, provide protection against counterfeiting. A counterfeiter, knowing a group code, cannot produce a V-STAMP label with the unique combinations of label A and B codes associated with that group for that year. The valid combinations of year codes, group codes, and label codes A and B used to generate all of the V-STAMP labels are recorded in the V-STAMP database when the labels are produced. They are usable only once, because they are marked as used in the V-STAMP database when they are read on a shipping item presented for shipment to the shipping service. A label could be copied, but the unique label identifier would be detected as previously used when processed by the shipping service.

In another embodiment of the V-STAMP label, the label codes are digitally signed to further enhance their security. One method for doing so is through the Information-Based Indicia Program (IBIP) “digital stamp”. The addition of encryption of a digital signature to the V-STAMP code further complicates any attempt to produce a V-STAMP label by anyone other than the shipping service. Any method of signing or encrypting the codes on the V-STAMP could be used without departing from the spirit and scope of the invention.

There is also a variety of labeling systems that can be substituted for the stacked bar codes shown in FIG. 2 without departing from the spirit and scope of the invention. The intended function is to carry the machine-readable codes comprising the label identifier. Any number of labeling schemes variations could be substituted without altering the intended function. Some examples of bar code systems applicable to V-STAMP label that could be easily substituted by one skilled in the art are given here along with the name of the organization that created or uses them:

Stacked Code 39 Bar codes (Intermec Corporation),

Code 49 2D Bar code (Intermec Corporation),

Aztec Code (Welch Allyn Inc),

Code 1 (AIM Inc),

Code 16K (AIM Inc),

DataGlyph (Xerox PARC),

Accuity CI Matrix,

Datastrip (Datastrip Inc),

Maxicode (AIM Inc),

PDF 417 (Symbol Technologies),

and QR Code (Nippondenso).

### V-STAMP LABEL GROUPS

V-STAMP labels are packaged and distributed in groups. Each V-STAMP label in a group has a common year code and a common group code, and group codes are not repeated in any year, therefore the combination of group code and year code identify all the V-STAMP labels in a group. A package of V-STAMP labels purchased or picked-up from a shipping service includes some quantity of V-STAMP labels. All of the V-STAMP labels in the package share the group code and year code, and they are the only V-STAMP labels produced with that group code and year code.

It is noted that the combination of a group code and year code could be replaced with a combined group code only, and that the division of the group identifier into a group code and year code serves as a convenience for identifying production and expiration dates of V-STAMP labels. A composite code could obviously be composed from the group and year code as defined by appending one to the other. Such variations in data element definitions are obvious to one skilled in the art, and do not depart from the spirit and scope of the present invention. The necessary element for the operation of the invention is that each package of V-STAMP labels is a unique group, that each of the V-STAMP labels in the package is identifiable as a member of that group.

In the preferred embodiment, the group and year codes are also printed outside the package of V-STAMP labels. In the stacked-bar code embodiment of the V-STAMP label, the bottom bar code (206) from the stack of three in FIG. 2 presents the year code and group code and that single bar code is printed on the outside of the package. It is not necessary to the invention that the method of labeling the group code on the outside of the package of V-STAMP labels be the same as that used in the V-STAMP labels themselves. Any other method for printing the group and year code on the outside of the package could be substituted by one skilled in the art without altering the intended function.

### V-STAMP DATABASE

The V-STAMP database records the assignment of individual V-STAMP labels to groups, the assignment of groups to customers, customer identification information, and label tracking histories. In the preferred embodiment, the database is organized into four tables, as defined in FIG. 3.

### V-STAMP DATABASE: LABEL STATUS TABLE

The label status table, FIG. 3a, is populated with a new record for each V-STAMP label produced. The four codes on the V-STAMP label (Year, Group, A, B) are replicated in the Label Status Table record, and the status of the label is summarized by flags. The Used flag indicates whether or not the label has been used on a shipped item. The Assigned flag indicates whether or not the group has been assigned to a V-STAMP customer account. Both the Used flag and the Assigned flag are initially set false for a new record in the table. Additional flags may be added to indicate special processing associated with the label. In FIG. 3a, an “No Radiation” flag field is shown. This flag is initialized false for a new V-STAMP. Particular customers are authorized to ship some items that would be damaged by radiation. These customer have their customer accounts set-up with a special flag set to indicate the customer is authorized to ship without radiation. When a group of labels is assigned to an account authorized for shipping without radiation, the label status records for all of the V-STAMP labels in that group are updated to set the “No Radiation” flag true. Note that there is no observable difference in the V-STAMP labels on items that will be routed around the radiation equipment, the labels do not contain any special information, they are instead linked by group number to a customer account with authorization for the special handling. There is then, no method for counterfeiting a “No Radiation” V-STAMP label, because there is nothing on the V-STAMP label that indicates special processing will be applied to the item.

The Used flag and Assigned flag from the label status table are redundant with other information in the tables. The status of the label, as used or not used, could be determined from a query on the Track History Table (FIG. 3c), and the status of the label, as assigned or not assigned, could be determined from a query on the Assigned Group Table (FIG. 3b). The Label Status Table summarizes this information to allow for speedier processing. Each shipped item presented to the shipping service must be scanned for its V-STAMP label (FIG. 1, 102) and the status (Used or not, Assigned or not) must be returned before further handling of the shipped item takes place. It is important that these status queries get a quick response from the V-STAMP database, so the required data is summarized in the Label Status Table.

This table will grow with the production of V-STAMP labels since each new V-STAMP label produced results in a new record to be added to the table. Since the size must be finite, older label records will be removed from the active table and archived or erased. Correspondingly, the V-STAMP labels will expire. They will be usable for some period of time after their year code, and then will not be recognized as valid V-STAMP labels when presented to the shipping service.

### V-STAMP DATABASE: ASSIGNED GROUP TABLE

The Assigned Group Table (FIG. 3b) records the assignment of a V-STAMP label year code and group code to a V-STAMP customer, as identified by their customer account code. An assignment record is generated when a group of V-STAMP labels is either distributed to a known V-STAMP customer, or distributed anonymously but then verified to be in the possession of a known V-STAMP customer.

Each of the labels in a group will already have a corresponding record in the Label Status Table, which was populated at the time the label is produced. When an entry is made in this Assigned Group Table, recording assignment to a customer, each of the records in the Label Status Table that match the year code and group code are updated to set the Assigned flag true.

Records in the Assigned Group Table expire with the expiration of the corresponding V-STAMP labels. The records are then removed from the table and archived or erased.

### V-STAMP DATABASE: TRACK HISTORY TABLE

The Track History Table is shown in FIG. 3c in a two-dimensional form. In other words, for each year code, group code, label code A, and label code B there is a series of records with Handling Point ID, Date and Time. The set of handling point records for each set of label codes is indicated by the indexing number in the first column of FIG. 3c. The table could be implemented as a single dimensional table by repeating the year, group, A, and B codes with each handling point, date, and time. It is shown here in the two-dimensional form to make clear the fact that multiple handling point, date, and time entries will exist for each label identifier.

The table is populated as a V-STAMP labeled shipped item passes through the shipping service. As the shipped item moves through the sorters, belts, irradiation equipment, onto trucks, trains, or planes, through additional processing centers and so forth the item is scanned repeatedly. The item is scanned and the V-STAMP label is read and an entry in the track history table is recorded at various points throughout the processing system.

The Track History Table holds the raw data to support web-based customer service where the customer can see the tracking history of their shipped item, as is currently the case for USPS Express Mail and some commercial shipping services. The Track History Table also supports cross-contamination analysis, discussed later in this specification.

### V-STAMP DATABASE: CUSTOMER TABLE

The Customer Table (FIG. 3d) records V-STAMP customer identification data along with a unique customer account code created at the time their account is created and the identity of the customer has been verified. The record includes multiple phone numbers for the customer account, as the customer may want to verify the receipt of a group of V-STAMP labels from any of their phone numbers, and their identity is confirmed by matching the number returned from caller-ID processing to one of the numbers in the customer table. Credit or debit card information is shown in the preferred embodiment. The credit or debit information is used to purchase V-STAMP labels if they are sold rather than distributed freely, and the credit or debit information also supports payment for special mail services such as priority mail, registered mail and others, which can be ordered with the V-STAMP Shipper described later in this specification.

The customer table also includes the ‘No Radiation Shipper Flag’, initialized false for new customer accounts, and updated to true only when the shipping service authorizes the customer to ship items that are not to be exposed to radiation. Various procedures could be employed to vet customers for this authorization, such as ensuring that their employees who have access to their V-STAMP customer code have had background checks. When and if the customer has passed the required checks, the flag is set true in the customer account record. In the preferred embodiment, this update is performed by a specially designated administrator in the shipping service with access and authorization to update the database. When the customer links a group of V-STAMP labels to this customer account, the label status record for each of those V-STAMP labels will be updated to set the ‘No Radiation’ field true.

The particular organization of the data items into tables given in FIG. 3 is not the only organization of data items possible to enable the invention. One skilled in the art could substitute alternative table forms, including adding or removing tables, without departing from the spirit and scope of the invention.

### V-STAMP LABEL PRODUCTION & CODING

The V-STAMP labels are produced in any fashion suitable for the manufacturing of labels with machine-readable codes printed on them. The selection of the codes to be printed and the transactions with the V-STAMP database are unique to the present invention. Referring to the elements of the V-STAMP label identifier; year code, group code, label code A and label code B., a random number generator selects label code A and label code B for a new label. The combination of the A and B values is checked against the existing V-STAMP database label status table to ensure the combination of group code A & B has not already been produced, for any group code, in that year. A group code is also randomly generated and assigned to some quantity of the random A & B code combinations. This group of labels, each with a unique A & B code combination, is printed and packaged for delivery to a single customer.

The database records the fact that the V-STAMP labels have been produced, but they have not been assigned to a customer account code or used, as indicated by initializing the assigned flag field false and the used flag field false in the record created in the label status table (FIG. 3a) for the new V-STAMP label.

### CUSTOMER ACCOUNTS

The V-STAMP system relies on authenticating the identity of the customer account holders. Originators of V-STAMP labeled shipped items are required to have established a customer account. V-STAMP label groups are activated by recording the assignment of a group code to a particular customer account code in the assigned group table (FIG. 3b). There are any number of means for authenticating the identity of a customer when establishing a customer account that may be deemed suitably secure, cost-effective and efficient for various instances of the present invention. Means that may be used, singly or in combination, include but are not limited to:

Getting the Social Security Number,

Getting a Visa number for foreign visitors,

Checking a passport or government issued identification,

Scanning a finger-print,

Scanning a retina.

### SPECIAL PROCESSING

The USPS is equipping postal centers with irradiation equipment to protect the country from further attacks by anthrax contaminated mail. There will be, however, shipped items that will be damaged or destroyed by such irradiation. These items will have to be handled specially if they are to be handled by the USPS at all. The V-STAMP offers a mechanism to handle this efficiently and securely. If for example, the manufacturer of film sensitive to the radiation used wants to ship film, the USPS would have the option to verify the customer has such a need, and then marks each group code for V-STAMP labels sold to that customer “no radiation” V-STAMP labels. Since the “No Radiation” flag is in the label status table (FIG. 3a) of the V-STAMP database, and not on the V-STAMP label itself, it cannot be counterfeited or invoked by altering the physical stamp on the package. When the package is processed, as in FIG. 1, the database record is retrieved (112), and the special handling flag is checked (126) and used to route the package around the irradiation equipment automatically, without manual intervention. These ‘special handling’ flags are not limited to irradiation of course, the database is a tool that allows the mail handling process to be customized on a customer by customer basis as needed, without manual labor. Note that the irradiation step is shown in FIG. 1 immediately after the V-STAMP label is read and its status checked. Alternatively, the irradiation may occur at some later point in the process, for example, the mail could be shipped to an intermediate processing center, irradiated there, and forwarded on to the destination. In order for the V-STAMP method to support automated special handling requests, it is only necessary that the irradiation, or special handling, occurs after the V-STAMP label has been scanned and the associated label status record has been retrieved. The V-STAMP label can be read again at the intermediate processing center to support the decision to go through or route-around special processing equipment.

### CROSS-CONTAMINATION CHECKING

In the event a shipped item is known or suspected to be contaminated with an agent that may cause cross-contamination, there is value in being able to identify items that may have been exposed to the agent as quickly as possible. The present invention provides for a method to expedite this check using queries on the V-STAMP database.

In the case where the suspect item has been found and has a V-STAMP label, the investigation can start with a query on the Track History Table, FIG. 3c, which returns a sequence of Handling Point ID's with the date and time that the item passed through the handling point.

Given this list of potentially contaminated handling point ID's, a further set of queries is made on the Track History Table to return the list of V-STAMP labels that passed through the same handling point ID after the suspect item and within some duration of time. The duration of time could be up to the current time, or could be limited to some shorter duration which is believed to be more appropriate for the contaminating agent, the particular piece of equipment, and the rate at which the equipment has been handling packages. Each of these V-STAMP labels is on a shipped item that has been potentially contaminated. The risk of contamination may be graded, such that is initially high and then drops, by some model believed to represent the risk of exposure.

A third set of queries can now be used to assess the risk that handling equipment other than that used to handle the original contaminated item has been contaminated. Each of the potentially cross-contaminated shipped items, identified by their V-STAMP labels in the above queries, is a potential source of further contamination. These queries result in lists of suspect secondary exposure handling points. A set of queries can be made on secondary exposure handling points to determine secondary exposure shipped items by their V-STAMP identification. The process may continue as necessary for the suspected contamination event, to tertiary exposure and beyond.

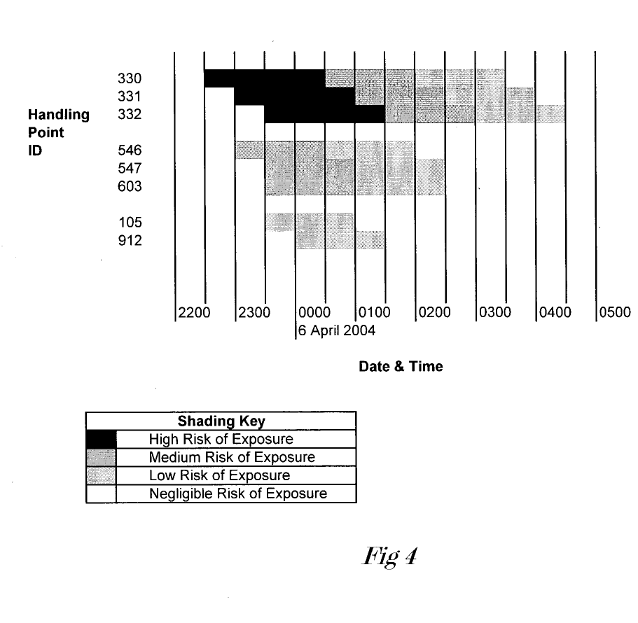

The result of these queries is to build up a set of data in a processor supporting the V-STAMP database or a processor with connectivity to it that represents the exposure hazard from various pieces of equipment in the shipping system. This is shown functionally in FIG. 4, which is a hypothetical map of the risk of exposure for shipped items passing through various pieces of equipment at various times. The pieces of equipment are identified by their handling point ID, along the ordinate of the graph. The date and time are indicated along the abscissa. The graph itself need never be prepared in this form to enable the invention, but the data used to generate the graph, the date, time and exposure risk for each piece of equipment does need to be collected in some form. A temporary table in the V-STAMP database could serve this purpose.

### RECIPIENT INITIATED EXPOSURE CHECK

The methods disclosed in this section allow the recipient of a shipped item to determine if any items they have received are potentially exposed and need special handling. Clearly such knowledge has potential for reduced health risks and costs to the recipient and the country as a whole.

A first embodiment of the recipient initiated exposure check is web-based. Other embodiments will be discussed subsequently.

Following the methods outlined in the previous section, an exposure event is followed by a set of queries on the V-STAMP database to determine an exposure map (FIG. 4) for the shipping service's handling equipment.

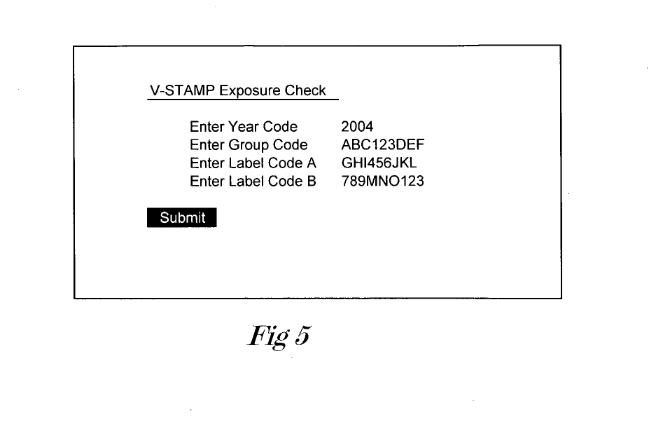

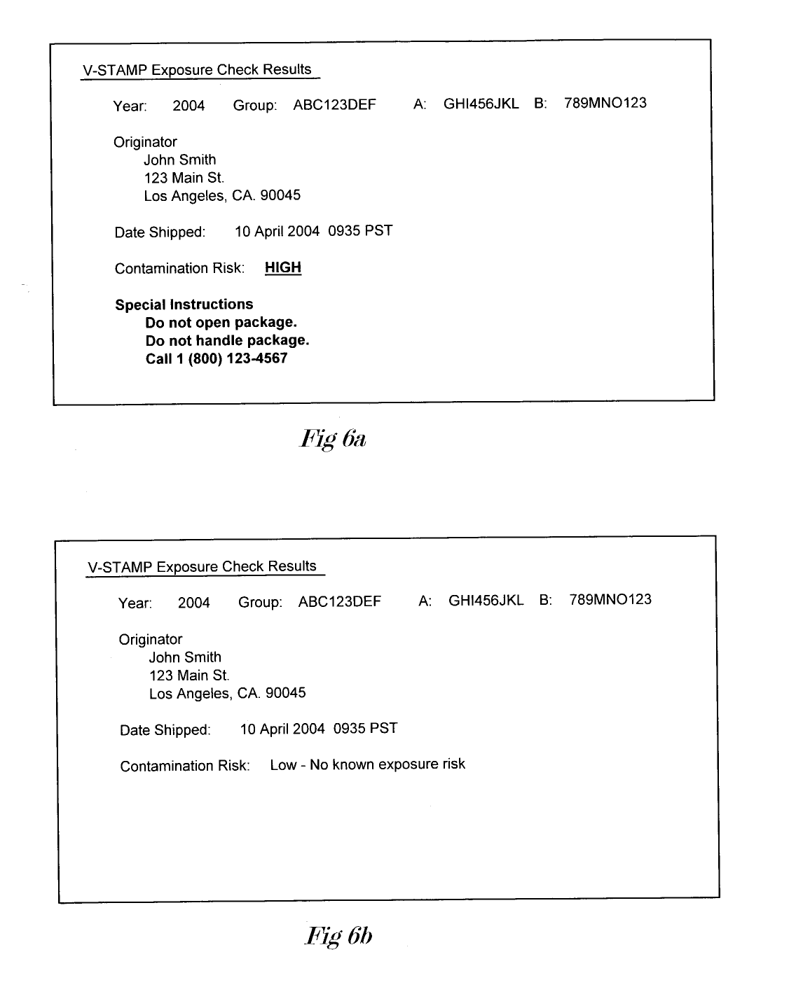

A contamination risk check is made by entering the V-STAMP identifier read from the V-STAMP label into a web-page and submitting it, as shown in FIG. 5 for example. Submitting the V-STAMP identifier results in a query on the Track History table (FIG. 3c) to determine if the track history for the item includes any handling points which were identified to have exposure risk in the exposure map (FIG. 4). The V-STAMP database is also queried to get the customer code assigned to the V-STAMP identifier from the Assigned Group table (FIG. 3b), and the originator's customer record is then retrieved from the customer table (FIG. 3d). These query results are used to create a results web-page for the V-STAMP identifier submitted. Two examples of web-page results are shown in FIG. 6, FIG. 6a shows a hypothetical result for a shipped item that passed through an handling point with high exposure risk. FIG. 6b shows results where there are no current exposure events, or any exposure events are not believed to have exposed any of the handling items used to handle this shipped item.

Other methods for submitting the exposure risk inquiry and returning the exposure risk assessment could be used. The exposure risk inquiry could be made over the phone using touch-tone codes, or voice recognition, or a live operator, with a voice message or live operator returning the risk assessment result and any special instructions. These substitutions are well-known in the current art, commercial shippers today allow for retrieval of the delivery status of a shipped item through a web-page or over the phone, with a query being made to the same database through either mechanism.

Another method for submitting the exposure risk inquiry is to make use of bar code scanners, either connected to privately-owned computer's or publicly available at the post office. The bar code scanner can be used to read the V-STAMP directly from the package in question, and eliminate the step of having someone enter the V-STAMP identifier by keyboard or by voice to generate the inquiry.

### ELECTRONIC DESTINATION ADDRESS

There is a body of prior art and ongoing developments in shipping services and postal services to optically scan, recognize, and store the destination address on a shipped item. The phrase electronic destination address is intended to refer to an address stored in a digital format on a computer. There are technical challenges associated with recognizing hand-written addresses. These challenges are being addressed and eventually shipping services will automatically scan, recognize, and record the destination address for a shipped item without human intervention. Current practice includes a person reading all or part the destination address and entering it through a keyboard. In particular, the zip-code may be read by a person and typed in for the USPS. The entire address is read and typed in by some commercial shippers. In any event, a shipping service either has today, or could be expected to have, an electronic destination address for each shipped item at the point at which the item is first scanned.

The present invention includes methods to make use of the electronic destination address. The electronic destination address can be used to form a query on the V-STAMP database customer table to determine if the name and address correspond to a V-STAMP customer. If they do, and the customer has stored new temporary or permanent address change information, address forwarding, holding, and address change processing can be automated. Thus a V-STAMP customer can update their account information, including entering a change of address, and have all shipped items forwarded without further effort on their part.

Another potential benefit of the present invention making use of the electronic destination address is to store the destination address with the V-STAMP database track history table (FIG. 3c), such that the final point in the track history is the destination address. This allows for a track history table query for the history of a given label identifier to return the destination address. In the event there is an exposure event, and contamination queries have been performed returning potentially exposed shipped items by V-STAMP label identifier, the destination address of each of those items can be retrieved as well, and efforts made to inform the recipient of the potential danger.

### USPS EMBODIMENT

For the USPS embodiment of V-STAMP, some estimates can be made of what resources would be required to implement V-STAMP and what provisions should be made to retrofit the methods of the present invention onto existing classes of service.

### USPS V-STAMP DATABASE

A USPS V-STAMP database embodiment will require servers and software sufficient to hold about 300 billion records at any given time. The label status table would be queried about 350,000 times per minute. The V-STAMP database, in distributed form, would operate over some 34,000 LAN's comprising the USPS network.

### USPS V-STAMP NETWORKS At THE LOCAL POST OFFICES

Existing postal clerks' terminals for manually entering customer and package information are usable for V-STAMP. Existing scanners may be usable reading V-STAMP labels at the Postal Clerks' terminals.

Scanners for reading V-STAMP labels during the sorting process would be added, and should require no more than 6 scanners per office, depending on how many different groups the shipped items get sorted into.

### AT PRIVATE BUSINESSES

A machine similar to a label machine that would affix the V-STAMP label to the mail. This would also have a lock on it to ensure that only people who were entrusted with the password would have access to the V-STAMP labels.

### USPS V-STAMP GROUP DISTRIBUTION

For stamped mail, the V-STAMP label would go on each piece of mail in addition to the normal postage stamp. Initially, these V-STAMP labels would only be sold in packs of 100, 1000, or 10,000 at the Post Office, or by phone-in order. Limited points of sale would be the most efficient way to ensure quality control of the initial V-STAMP verification process. Labels that are ordered by phone would be activated in the same way a new credit card is activated, a call in from the home phone to activate the purchased labels. Individuals who use the phone-in order method would also have to have an established USPS customer account. The USPS accounts may have a bank account tied to it, to support automatic debit for purchase of V-STAMP labels (FIG. 3d).

### METERED MAIL

Although Metered Mail can currently be traced to the individual machine that produced the label, it would not be able to handle the other future benefits that the V-STAMP can offer. For example, since a record is kept of the entry of each V-STAMP labeled piece of mail into the postal system, cross-contamination containment and other automated account benefits discussed in this specification are not possible. With this in mind, metered mail will be handled and processed the same exact way as regular stamped mail, and V-STAMP labels would be used on metered mail.

Due to the high volume of mail many companies have, a machine may be used for the specific purpose of affixing the V-STAMP label automatically to the letter. This machine would work in the same exact way as an address label machine works. It would also have a locking system to control access to it. The machine would be protected by a password, combination, key, swipe card, or some similar mechanism to prevent unauthorized use.

### OUTGOING AIR MAIL

Currently all Air Mail has a process where the sender's name is established. It is not, however, verified for accuracy against any form of identification, therefore the security can be enhanced by requiring the use of V-STAMP labels on outgoing air mail.

### BULK MAIL

Bulk mail handled by the USPS can currently be traced back to the original sender through form 3553 and other permits necessary to process mail in bulk. Bulk mail labels, however, are not unique and have no protection against re-use or counterfeiting, therefore V-STAMP label use in addition to or in lieu of bulk mail labeling should be implemented to ensure process conformity and security throughout all types of mail.

### OUTGOING MILITARY MAIL

Outgoing Military Mail would use V-STAMP labels, but the servicemen and women would not be charged any fee for the use of them, if in fact they are sold rather than freely distributed to the general public.

### INCOMING AIR MAIL FROM OTHER COUNTRIES

USPS would consider the Foreign Post Office that is forwarding the mail to them as their customer, so each V-STAMP label group code would be associated with a customer account designating the foreign post Office.

The USPS would also require every Foreign Post Office to have a minimum standard for their I.D. Verification process for Outgoing Air Mail being sent to the US. This may mean a process of certification that the identities of original shippers are actually checked.

One might expect varying levels of compliance, and this is another problem that V-STAMP can help address. Assume, for example, nation XYZ was having trouble with terrorists and was unable to fully certify the origin of parcels and mail heading to the US. The national V-STAMP database would identify which V-STAMP group codes were shipped to the XYZ central post office. Inbound mail with a V-STAMP label from one of these groups could be routed to special handling equipment, perhaps for detection of chemical, biological and nuclear threats.

### ORIGINATING MAIL WITH SPECIAL SERVICES

A method for originating mail making use of special services in a fashion consistent with the other elements comprising the present invention has been developed.

Special shipping services refers to any method of shipping USPS, foreign post office, or commercially shipped mail or packages where additional paperwork filings, charges, or tracking devices are involved. These services include, but are not limited to:

Insured Mail or Packages

Registered Mail,

Return Receipt Requests for Mail or Packages,

Delivery Confirmation for Mail or Packages,

Certified Mail,

Express Mail or Packages,

Priority Mail.

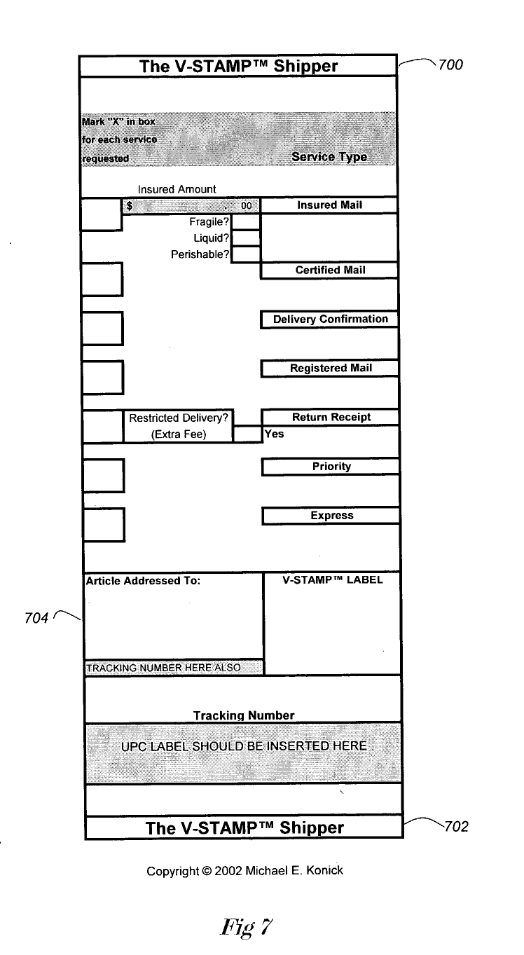

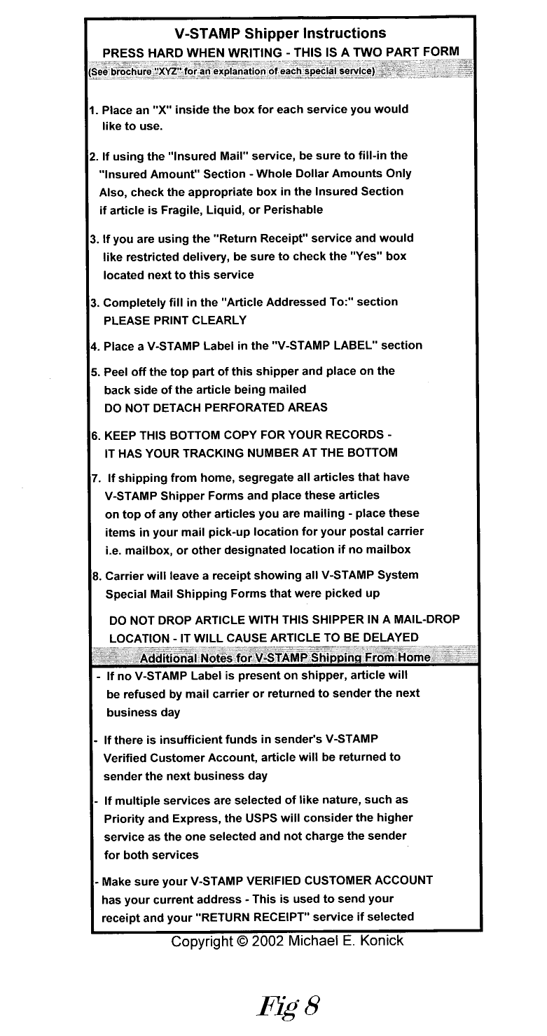

The originator can make use of a V-STAMP Shipper to designate special shipping services from their home. The preferred embodiment of the V-STAMP Shipper is shown in FIG. 7 (front) and FIG. 8 (back).

The V-STAMP Shipper gives the sender a conformed method of choosing one or more of these special shipping methods and allows them to do this from their home or office. Conformed method means that any special shipping service that the USPS, foreign post office, or commercial shipper would like to offer their customers from a home location would be located on one V-STAMP Shipper. The V-STAMP Label that gets attached to it links the V-STAMP Shipper to a customer account. This allows the USPS to bill all charges to the customer's account when the V-STAMP Shipper is processed at the local post office.

In the preferred embodiment of the V-STAMP Shipper shown in FIG. 7 (front) and FIG. 8 (back), the originator can designate the special shipping services desired on the V-STAMP Shipper. Another embodiment of the invention would be to have separate, distinct, V-STAMP Shippers for each special shipping service required. In either embodiment, the V-STAMP Shipper is used in conjunction with the V-STAMP label to uniquely and securely identify the originator of the package or mail, and designate an existing account against which the cost of the special shipping services designated are charged.

The V-STAMP Shipper has a tracking number distinct from the unique V-STAMP Label identifier. Either the V-STAMP Shipper tracking number or the V-STAMP Label identifier can be used as a key to access the tracking history for the shipped item.

It is to be understood that additional special shipping services that are not shown in the preferred embodiment of the V-STAMP Shipper in FIG. 7 and FIG. 8 affect only the detailed design of the form. A different set of available services requires only a change in the detailed design of the form shown in FIG. 7 and FIG. 8. Such changes would be obvious to one skilled in the art, and are within the scope of the invention. The objective of the invention is to allow people to send mail or packages with any selected service levels and features without leaving their home or office. Another objective is to allow the post office or commercial shipper handling the shipment to combine these services onto one form for processing mail or package wherever its received.

The V-STAMP Shipper pictured in FIG. 7 and FIG. 8 is a carbon-copy form with at least two parts, the original and one or more copies. The preferred embodiment has dimensions of 6¾″×3½″, but the size is not a factor in the V-STAMP Shippers functionality.

The bottom copy will be the carbon copy record for the sender to hold on to. The backside (FIG. 8) of this copy also contains the instructions for filling out the front side (FIG. 7). The bottom copy has a one-piece design.

The top copy will be the copy that gets attached to the article being shipped out. It will be a 3-piece design—the body, which will be 5¾″×3½″ and 2 perforated wings (700, 702) that will be 1/2″×3½″ each. Each of the 2 perforated wings has an adhesive underneath it so that the sender can attach this V-STAMP Shipper to the article they are sending.

The purpose of the perforations is to allow the firm or post office handling the article to tear this V-STAMP Shipper off at the point of initial processing. This way the V-STAMP Label can be kept for record retention purposes at the post office or shipping firm.

The “Article Addressed To” (FIG. 7, 704) section will be a label that the postal clerk can peel off and attach to Express or Priority Mail Labels, Return Receipt Labels, or any other shipment label. When the post office or shipping firm handles the article, this “Article Addressed To” label is then re-used, if required, and the necessary charges are made to the customer account linked to the group code read from the V-STAMP label.

The following methods are discussed for V-STAMP special services shipping as handled by the US Post Office. This is one embodiment of the invention. Alterations to this procedure for foreign post offices or commercial shippers will be obvious to one skilled in the art.

### HOME USE OF V-STAMP SHIPPER

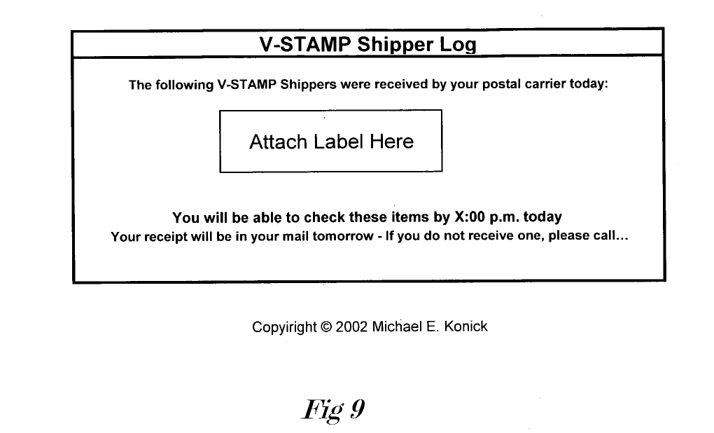

The originator gets a V-STAMP Shipper from the post office, where the forms are free to pick-up and can be found inside the post office or attained from a postal carrier. The originator fills out the V-STAMP Shipper and can use it to initiate the shipment from the home or from a mail drop-off point, such as a mailbox. Postal carrier picks-up mail and scans each article with a V-STAMP Shipper attached to it. The scanner unit then prints a receipt that reports every tracking number that was picked-up at this location for delivery. The receipt is left with the originator, attached to the V-STAMP Shipper Log form shown in FIG. 9.

The originator keeps this log form with the tracking number receipt attached as a record of the USPS picking up their V-STAMP Shipper article(s).

The postal carrier will keep all articles with V-STAMP Shippers segregated so that they may be processed immediately upon return to the Post Office, where they are handed-off to a designated clerk responsible for V-STAMP Shipper articles. The carrier also attaches the mobile V-STAMP Shipper scanner to a computer carriage that will upload all of the information regarding items that were scanned for the day. This logs the tracking number into the V-STAMP Database with the time it was scanned by the postal carrier, but does not attach the tracking number to an individual yet. These records are marked with a flag in the V-STAMP Database to indicate that these V-STAMP Shippers were originated from a home location.

The process followed to handle V-STAMP Shipper articles is given in detail for the USPS embodiment. The designated postal clerk for V-STAMP Shippers processes each V-STAMP shipper article by setting the article on the postage meter scale, keying in the zip code information that is on the shipper, and entering the special services that were designated on the V-STAMP Shipper. There may be additional information that may be pertinent to that designated service, such as the delivery date for Express Mail.

After all the services have been entered, the total fee will be calculated, and the postal clerk can be prompted to verify the shipping service information that they've entered before going any further with these charges.

The postal clerk then scans the V-STAMP Label that is on the V-STAMP Shipper. The V-STAMP label is checked by query to the label status table in the V-STAMP database to ensure it is assigned and unused. An label status that is not assigned or already used results in the associated article being set aside for further investigation, and the normal processing described below does not take place.

If the Label is assigned and not used, the V-STAMP database is queried to get the customer account code. The customer account code is used to query the customer table (FIG. 3d) to determine if the account has been set-up for automated credit or debit payments. If so, the necessary fees for the special services indicated on the V-STAMP shipper are charged. If the account is not set-up for credit or debit payments, or there are insufficient funds for the transaction, further processing of the article for shipment to the designated address is stopped, and the USPS can either return the article or send a letter to the originator.

If the customer has sufficient funds, the transaction gets posted to the sender's account, and the shipping of the article continues. The transaction creates a new entry in a Shippers table in the V-STAMP database. The Shippers table records the V-STAMP Shipper tracking number and the unique V-STAMP label identifier associated with it. The Shipper record includes a set of flags indicating which services were selected on the V-STAMP shipper, a record of the time and date that the article was picked up by the postal carrier, and a record of the time it was processed by the postal clerk.

If the services selected require special markings and or packaging, such as Express or Priority Mail: the necessary label would get printed out from the information in the V-STAMP Database. The current USPS Mailing Label design could be used with the removal of the pre-printed tracking number. The label would include instead, the V-STAMP Shipper tracking number, printed out with the rest of the label markings.

Referring now to the fields in the special labels for services such as Express and Priority mail, the “From:” information would be taken from the V-STAMP Database Customer Table tied to this transaction. The “To:” information would be from two places:

The ZIP+4 would print out from the zip code information that was keyed in by the postal clerk to initially establish the charge for this service. The rest of the “To” information would be taken from the initial V-STAMP Shipper that the sender filled out at their home. The “Article Addressed To” section on this V-STAMP Shipper is a label that the postal clerk can just peel off and attach to the Express or Priority Mail Mailing Label.

If special packaging is necessary, an Express Mail envelope for example, the postal clerk will remove the V-STAMP Shipper from the article and insert the article into the special packaging. The postal clerk will attach the Express or Priority Mail Mailing Label completed as described in the preceding paragraphs to the outside of the package and seal the package.

If the services that were selected do not require special packaging, a label identifying what services are to be used is printed out when the charge for the transaction is successful.

This is the actual label that stays on the article being mailed. This Service Label will also have the tracking number from the initial V-STAMP Shipper on it. The postal clerk will attach the label to the article being mailed

### V-STAMP SHIPPER RETURN RECEIPT PROCESSING

If Return Receipt was also one of the services requested, then the sender's address, taken from their V-STAMP Customer Account will print out on a label to attach to the Return Receipt Form. The current USPS Return Receipt Form will be used.

The “Article Addressed To:” section (704) will be obtained from the original V-STAMP Shipper. The postal clerk will peel off the “Article Addressed To:” section on the V-STAMP Shipper and attach it to the Return Receipt Form. This label also has the V-STAMP Shipper tracking number on it.

Two items will then need to be filled out manually by the postal clerk, the Service Type, and whether or not it is a restricted delivery. The return receipt form is attached to the shipped item as is currently done. Further processing of the shipped item is in accordance with current practice at the post office.

### V-STAMP SHIPPER CONFIRMATION

Another safety measure used to protect against fraud or stolen labels is to send a confirmation mail to V-STAMP customers making use of V-STAMP Shipper service. Once all V-STAMP Shippers have been processed for the day, the V-STAMP Database is queried to print out a receipt for each customer itemizing all of his V-STAMP shipments for some time period, (the previous day, for example). This receipt could then be placed in the customer's mail the following day since their V-STAMP database Customer Account has their current address on it. If the V-STAMP customer is unaware of any of the activities that are on their account, they can contact the USPS immediately to get the situation rectified.

The use of different forms for different shipping services after the V-STAMP shipper is processed is compliant with current USPS practice. The opportunity exists to replace a number of these forms with one universal shipper or label that would attach to blank shippers. This would greatly cut down on costs for different forms, dedicated printers for specific labels, and/or the cost of man-hours to switch between different forms while processing. Additionally, some of the 2-part and 3-part forms may be able to be done away with because there is now a record of each sales transaction in the V-STAMP Database that different departments within the USPS could access whenever they needed them.

If the originator has any big packages or multiple V-STAMP Shippers that exceed a stipulated amount set by the USPS, the USPS should have a hot-line number where the sender could call to schedule a pick-up. This service is currently in place for Express, Priority, and Global Priority Mail.

The V-STAMP Shipper, in conjunction with the other elements of the present invention, allows the user to designate special services normally requiring a visit to the post office from the home or office.

I claim:

1. A method for verifying the identity of the originator of an item presented for shipment to a shipping service comprising the steps of:
producing machine-readable labels each with a unique label identifier wherein the unique label identifier comprises a group code and a randomly-selected label code;
packaging the machine-readable labels for distribution as a group defined by a common group code;
verifying the identity of an originator to establish a customer account wherein the customer account has a unique customer code;
distributing a group of machine-readable labels to the originator with a means for verifying that the originator has taken receipt of a particular package of labels wherein the common group code identifying the group is recorded as having been assigned to the customer code for that originator in a database;
scanning an item presented for shipment to read the unique label identifier from the machine-readable label affixed to the item;
querying the database to determine if the group code of the unique label identifier scanned was recorded as having been assigned to a customer code wherein the scanned item is set aside for investigation if the group code was not recorded as having been assigned to a customer code.

2. The method of claim 1 further comprising the steps of:
initializing the value of a used flag in the database for each unique label identifier to false when the machine-readable label with that unique label identifier is produced;
checking the value of the used flag in the database for the unique label identifier on the machine-readable label affixed to an item presented for shipment;
setting the item aside for investigation if the used flag in the database for the unique label identifier on the machine-readable label affixed to the item presented for shipment is true; and
updating the value of the used flag in the database for the unique label identifier on the machine-readable label affixed to the item presented for shipment to true,
whereby the machine-readable labels are known to have been used only once as a result of the used flag being set true when the unique label identifier is read from a label affixed to a package.

3. The method of claim 1 wherein the unique label identifier of the machine-readable label comprises:
a year code identifying the year the label was printed;
a group code common to a group of machine-readable labels packaged together for distribution;
a first randomly-selected label code; and
a second randomly-selected label code.

4. The method of claim 1 wherein the means for verifying the identity of the originator to establish the customer account comprises having a shipping service clerk check a driver's license presented by the originator.

5. The method of claim 1 further comprising the step of:
issuing a machine-readable card to an originator after their identity has been verified and their customer account established with a unique customer code wherein the unique customer code is readable from the machine-readable card,
wherein the means for verifying an originator has taken receipt of a particular package of labels is reading the customer code from the card at the time the package of labels is distributed to the originator.

6. The method of claim 1 additionally comprising the steps of:
approving one or more originators for special handling of their shipped items;
updating the customer account for approved originators to set a special handling flag true in the customer account record; and
checking a database record for the unique label identifier on the machine-readable label affixed to a shipped item to invoke special handling in the shipping service;
wherein when an approved originator verifies taking receipt having taken receipt of a particular package of labels
wherein the common group code identifies the group, a database record for each label in the group updated to indicate special handling.

7. The method of claim 6 wherein the special handling procedure is routing the shipped item around irradiating equipment so the item is not exposed to radiation.

8. The method of claim 1 wherein the means for verifying an originator has taken receipt of a particular package of labels comprises listening to a phone call placed by the originator wherein the originator recites their customer code and the group code from the package of labels in their possession.

9. The method of claim 8 wherein the phone call is received by an operator who manually enters the assignment of the group code from the package of labels in the possession of the originator to the customer code of the originator in the database.

10. The method of claim 8 wherein the phone call is received by an automated voice-recognition system which enters the assignment of the group code from the package of labels in the possession of the originator to the customer code of the originator in the database by passing a message to the processor hosting the database.

11. The method of claim 8 additionally comprising the steps of:
recording at least one phone number in the database for the originator when their customer account is created;
processing the caller ID signal when the phone call is received;
verifying that the caller ID signal reports a phone number that matches a phone number recorded in the database for the customer account identified by the customer code recited by the originator;
wherein the assignment of the group code to the customer code in the database is rejected if the call is not placed from a phone number previously stored in the database for the customer account identified by the customer code.

12. A method for tracking the processing of an item to be shipped through the handling points in a shipping service such that a tracking history is developed which records the date and time the item passes through the handling points comprising the steps of:
verifying that a machine-readable label with a unique label identifier is in the possession of a originator wherein the originator's identity has been verified;
accepting an item for shipment with the machine-readable label with a unique label identifier affixed to the item;
reading the unique label identifier from the machine-readable label affixed to the item with scanners at handling points distributed throughout the shipping service; and
storing the unique label identifier, time, date, and handling point identifiers as track history records in the database.

13. The method of claim 12 wherein the information printed on the machine-readable label with a unique identifier comprises:
a year code identifying the year the label was printed;
a group code common to a group of machine-readable labels packaged together for distribution;
a first randomly-selected label code; and
a second randomly-selected label code.

14. A method for determining a set of handling points that may be sources of cross-contamination as a result of shipping a item known or suspected to be contaminated by a nuclear, chemical or biological agent as recited in claim 12 and further comprising the steps of:
reading the unique label identifier from the machine-readable label affixed to the suspected item wherein the suspected item has already passed through all or part of the shipping service en-route to its destination address;
querying the database for track history records matching the unique label identifier of the suspected item wherein the query returns the set of handling point identifiers, dates, and times that were stored when the suspect item passed through the shipping service;
estimating the duration of at least one level of cross-contamination risk for each handling point identifier retrieved wherein a level of cross-contamination risk is an estimate of the likelihood that an item passing through the same handling point suffers cross-contamination; and
storing the resulting list of handling point identifiers, dates, times, durations, and cross-contamination risk levels in an exposure map table in the database.

15. A method for the recipient of a shipped item to determine the risk that the item was contaminated as a result of another known or suspected contaminated item having been shipped through the same shipping service as recited in claim 12 and further comprising the steps:
querying the database for track history records with unique label identifiers matching the unique label identifier from the machine-readable label affixed to the recipient's shipped item;
querying, for each track history record, the exposure map table for the handling point identifier in the track history record and wherein there is such a match, comparing the date and time from the track history record to the date time and duration from the exposure map wherein if the date and time from the track history record is after the date and time from the exposure map but before the end of the duration, the query is counted as a hit, whereby it is determined if the recipient's shipped item hit a handling point when there was a risk of cross-contamination; and
reporting the existence of any hits to the recipient.

16. The method of claim 13 additionally comprising the step of:
entering the unique label identifier from the machine-readable label affixed to the recipient's shipped item into a web-page to request a cross-contamination check
wherein reporting the existence of any hits to the recipient is accomplished on a web-page posted in response to the web-page cross-contamination check request.

17. The method of claim 13 additionally comprising the step of:
calling a phone number established for requesting cross-contamination checks and reciting the unique label identifier from the machine-readable label affixed to the recipient's shipped item to request a cross-contamination check
wherein reporting the existence of any hits to the recipient is accomplished by voice over the phone connection established by the call to the phone number.

18. A method for designating special postal services to be applied to a mail item from the home or office comprising the steps of:
completing a service request form and affixing it to the mail item;
affixing a machine-readable label with a unique label identifier to the service request form;
scanning the machine-readable label with a unique label identifier affixed to the mail item at the receiving postal center;
querying a database to retrieve the customer account record for the customer known to be in possession of the machine-readable label with the unique label identifier affixed to the service request form;
charging the payment account for the cost of the special postal services, wherein the payment account is one of a credit account or a debit account.

19. A system for verifying the identity of the originator of a shipped item handled by a shipping service comprising:
preprinted, machine-readable labels, each with a unique label identifier, which are produced, packaged, and distributed in groups, wherein one of the labels is affixed to each shipped item by the originator;
a plurality of scanners for reading the machine-readable labels installed at various handling points in the for shipped items within the shipping service;
a processor hosting voice recognition software responsive to audio from a phone line;
an operator station where data items can be manually entered by a shipping service clerk; and
a database hosted on a processing system accessible by the scanners, by the operator station, by the processor hosting voice recognition software; and
a shipped item-handling apparatus responsive to messages from the database wherein individual shipped items are set aside from the automated shipped-item handling flow following scanning by one of the plurality of scanners and a query on the database for status information on the shipped item,
wherein the originator's identity has been verified by a shipping service clerk and a customer account with a unique customer code been created and stored in the database, the originator verifies receipt of a package of machine-readable labels by calling on the phone line and reciting the group code for the package of machine-readable labels and the unique customer code for the originator's customer account, the scanning of a machine-readable label by one of the plurality of scanners is signaled to the database such that the database records for that unique identifier flagged as used, the unique identifier from one of the machine-readable label affixed to a package presented for shipment to the shipping service is signaled to the database to retrieve the status information for that label, wherein the status information further comprises:
a flag indicating whether or not the unique identifier has been previously scanned by one of the plurality of scanners in the shipping system;
a flag indicating whether or not the unique identifier comes from a label packaged in a group verified to have been received by an originator with a customer account.

20. The system of claim 19 wherein the processor hosting voice recognition software responsive to audio from a phone line is additionally responsive to caller ID signals from the phone line, and the customer account with a unique customer code created and stored in the database includes at least one phone number for the originator whereby the phone number from which the originator verifies the receipt of a package of machine-readable labels is verified to be a phone number for the originator as determined by matching a phone number from the customer account record. 21. The system of claim 19 wherein the unique identifier of each preprinted machine-readable label comprises:
a year code for the year in which the label was manufactured;
a group code common to a group of the preprinted machine-readable labels packaged together for distribution;
a first randomly-selected label code; and
a second randomly-selected label code.
